(19) United States
(12) Patent Application Publication
(10) Pub. No.: US 2003/0119482 A1
(43) Pub. Date: Jun. 26, 2003

(54) Making secure data exchanges between controllers

(76) Inventor: Pierre Girard, La Destrousse (FR)

Correspondence Address: BURNS DOANE SWECKER & MATHIS L L P, POST OFFICE BOX 1404, ALEXANDRIA, VA, 22313-1404, US

(21) Appl. No.: 10/296,547

(22) PCT Filed: May 25, 2001
(86) PCT No.: PCT/FR01/01621

(30) Foreign Application Priority Data
May 26, 2000 (FR) 00/06880

(51) Int. Cl. H04M 1/66; H04M 1/68; H04M 3/16; H04M 1/00; H04B 1/38

(52) U.S. Cl. 455/411; 455/558

(57) ABSTRACT

The invention concerns a method for making secure data exchanges between first and second controllers (SIM, CA) such as an identity card (SIM) of a radiotelephone terminal (TE) managing communications to a telecommunications network (RR) for applications in an additional card (CA). A server (SO) of the identity card operator, or a server (SP) of the additional card transmitter matches with the identifier a mother key to determine the key of an application selected in the additional card. At least a parameter depending on the key is transmitted to the identity card (SIM) to make secure a data exchange. The identity card is thus customized on line for each application.

The present invention concerns the protection of data exchange between two controllers.

To protect the dialogue between the two controllers, one known solution consists of pre-storing a mother key in the first controller, such as for example that of a security module in a point of sale terminal, and pre-storing daughter keys in second controllers for user smart cards, such as credit cards or electronic purse cards. The daughter key of a second controller results from the application of the mother key and a serial number of the second controller, the smart card, to a key diversification algorithm.

However, the invention relates more particularly to another context in which two controllers emanate from two distinct legal entities who a priori are not sufficiently connected for one to impose security data on the other.

According to an example to which reference will be made hereinafter, one of the legal entities is the operator of a radio telephony network who sells removable identity smart cards or SIM (Subscriber Identity Module) cards in mobile radio telephony terminals, which each contain a “first” controller. The other legal entity is an issuer of application smart cards, referred to as additional cards, each containing a “second” controller, which are introduced into additional card readers in terminals.

In this case, the user of each terminal can acquire various additional cards emanating from various card issuers, and a priori each containing several applications.

The telephone operator selling the SIM cards is incapable of providing, when they are parameterised, for the introduction of all the mother keys into each SIM card, relating to the various additional cards or to the applications which they contain. It is therefore impossible to pre-store all the mother keys of the additional cards in the SIM identity cards.

In addition to the practical aspect of the storage of the mother keys in all the SIM cards, there is a very great risk in entrusting the mother key to all the users. This is because, with regard to security, if a card is “broken”, that is to say if all the keys which it contains are obtained, under no circumstances should all the security means be threatened. This principle is precisely flouted if the SIM cards contain the mother key. Obtaining only one of these mother keys associated with only one of the SIM cards would make it possible to manufacture clones of any additional card.

The invention aims to mitigate the inadequacies of the prior art at least for the particular context above, so as to protect a data exchange between the controllers of any card and any additional card.

To this end, a method for protecting data exchanges between first and second controllers, the first controller managing communications to a telecommunications network for applications implemented in the second controller, the second controller containing a controller identifier and keys for the applications derived from a mother key, is characterised by the following steps for each application selected in the second controller:

transmitting the identifier of the second controller and an identifier of the selected application from the second controller to a distant security means through the first controller,

making a mother key in the security means correspond to the identifier of the second controller,

determining the key of the selected application according to the selected application identifier transmitted, the corresponding mother key and the identifier of the second controller in the security means,

transmitting at least one parameter dependent on the application key determined from the distant security means to the first controller, and

using the parameter in at least the first controller for protecting at least one data exchange relating to the selected application between the first and second controllers.

The first controller, such as that of a SIM identity card, is personalised on the line for each use of an additional card containing the second controller, that is to say for each application, by means of the parameter dependent on the determined key of the selected application. The SIM card is not personalised in order to exchange data with a predetermined initial card and does not in advance contain a predetermined key, but is provisionally personalised in order to exchange data with an additional card whose issuer is recognised in the security means.

According to first and second embodiments, the parameter is the determined application itself which is transmitted in enciphered form from the distant security means to the first controller. Even in these embodiments, the key is not used directly to protect the data exchanges between the controllers, but is diversified at each session of the application, or at each transmission of a data unit from one to another of the controllers, as will be seen in the detailed description of the invention.

The distant security means is, according to the first embodiment, a server in the said telecommunications network and contains a table for making sets of second-controller identifiers correspond to mother keys.

According to the second embodiment or a third embodiment, the distant security means comprises a first server included in the telecommunication network and containing a table for making sets of second-controller identifiers correspond to second-server addresses, and second servers connected to the first server and associated respectively with sets of second-controller identifiers corresponding to mother keys. The second server is addressed by the first server in response to the identifier of the second controller transmitted, and determines the key of the selected application and transmits at least the said parameter to the first controller through the first server.

According to a first variant, the application key is used in the first controller in order to participate in an authentication of one of the first and second controllers by the other controller, and then in an authentication of the other controller by the said controller in response to the authenticity of the said one controller, before executing a session of the application selected solely in response to the authenticity of the said other controller.

According to a second variant, the application key is used in the first controller in order to determine an enciphering key dependent on a first random number supplied by the second controller to the first controller and a second random number which is supplied by the first controller to the second controller in order to determine the enciphering key in the second controller, so as to encipher and/or sign a data unit with the enciphering key to be transmitted from one of the controllers to the other.

According to the third embodiment, instead of the key of the application selected, several sets of parameters dependent on the determined key and not comprising the latter are transmitted by the second server to the first controller. The key is thus not transmitted to the first controller, which increases the security, and it is only pairs of a number and a parameter dependent on this number and on the key which are transmitted.

Other characteristics and advantages of the present invention will emerge more clearly from a reading of the following description of several preferred embodiments of the invention with reference to the corresponding accompanying drawings, in which:

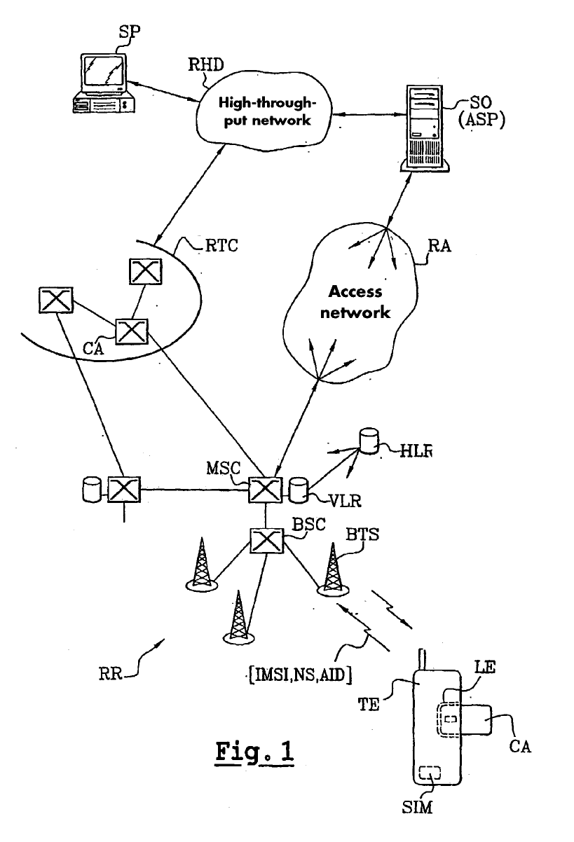

FIG. 1 is a block diagram of a system of networks for implementing the protection method of the invention from a mobile terminal;

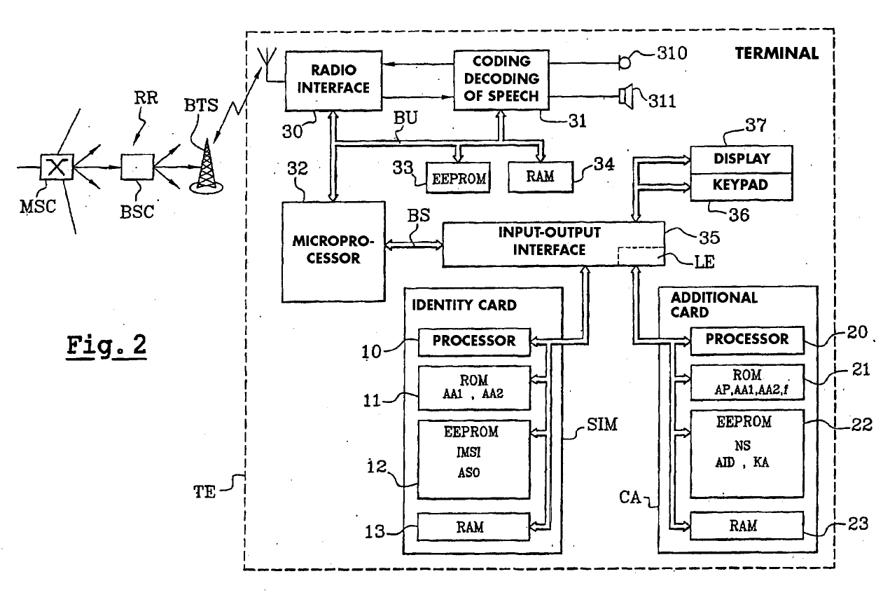

FIG. 2 is a detailed functional block diagram of a mobile radio telephone terminal provided with an additional smart card;

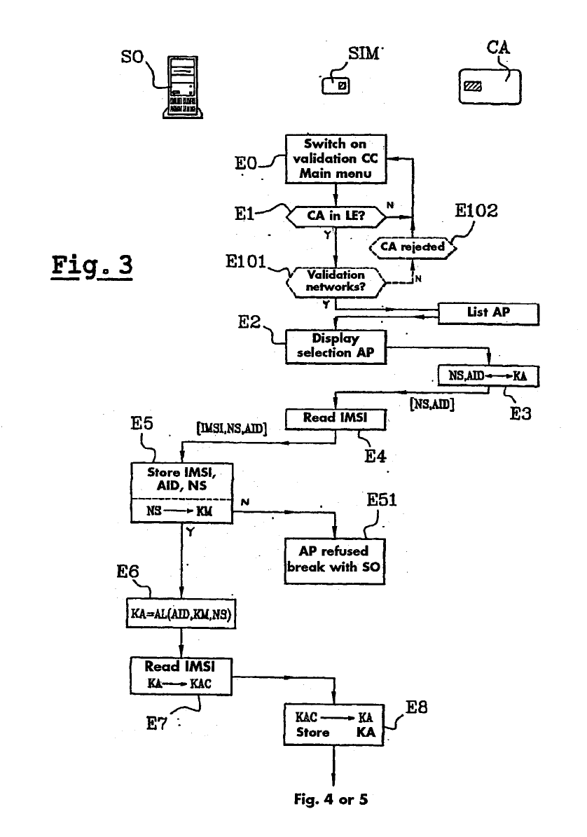

FIG. 3 is a security algorithm according to a first embodiment of the invention;

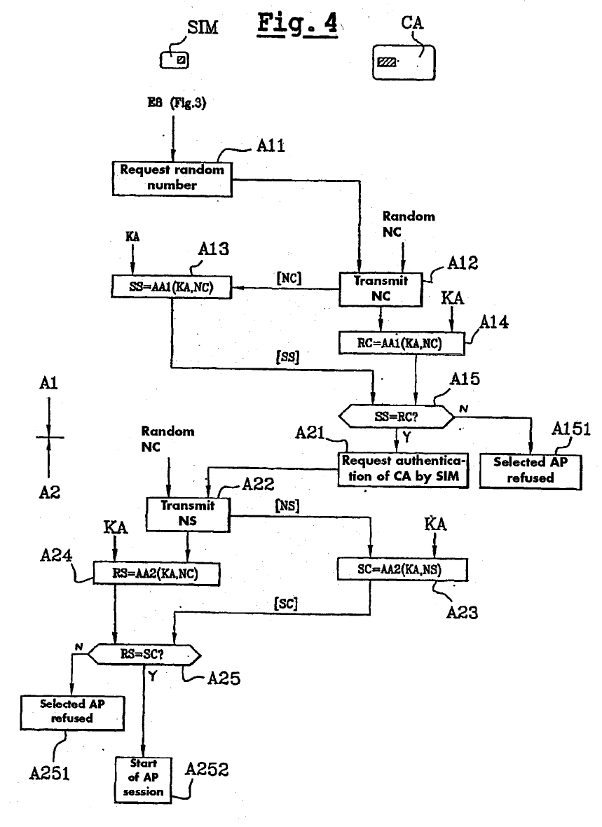

FIG. 4 is a mutual card authentication algorithm for the first embodiment or a second embodiment of the invention;

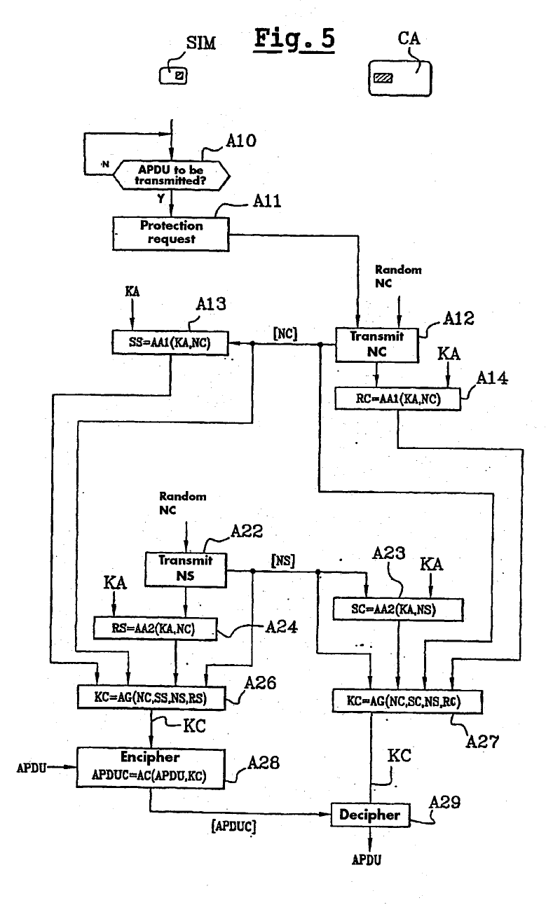

FIG. 5 is an algorithm determining a data unit enciphering key for the first and second embodiments of the invention;

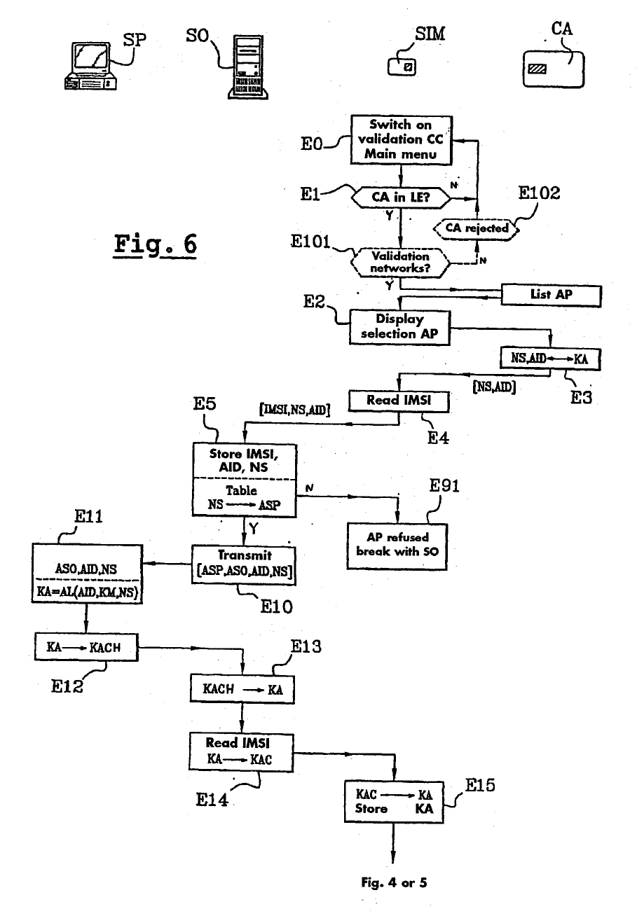

FIG. 6 is a security algorithm according to the second embodiment of the invention;

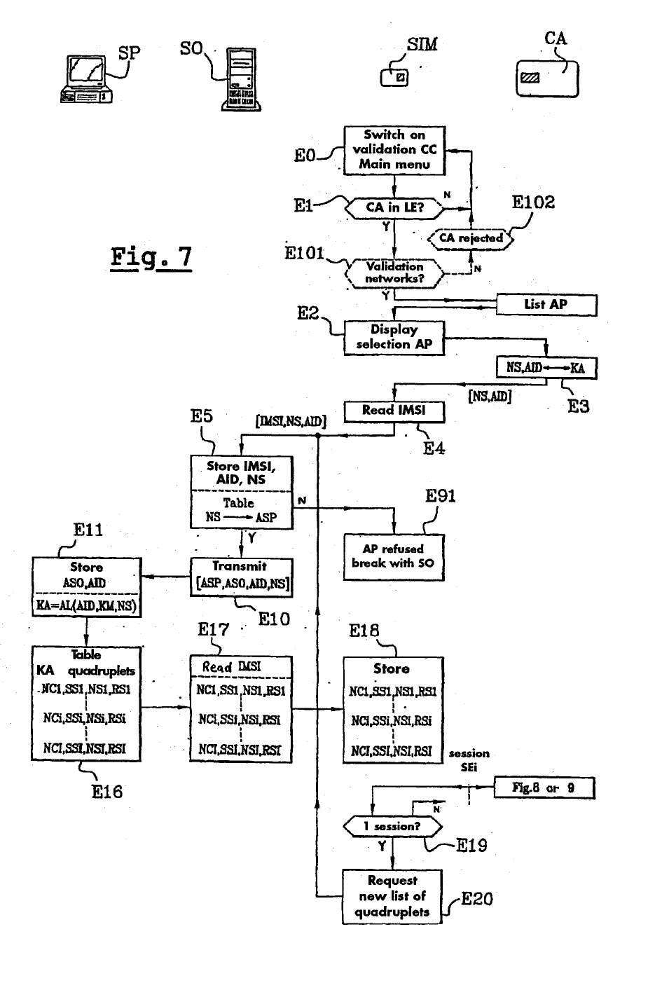

FIG. 7 is a security algorithm according to a third embodiment of the invention;

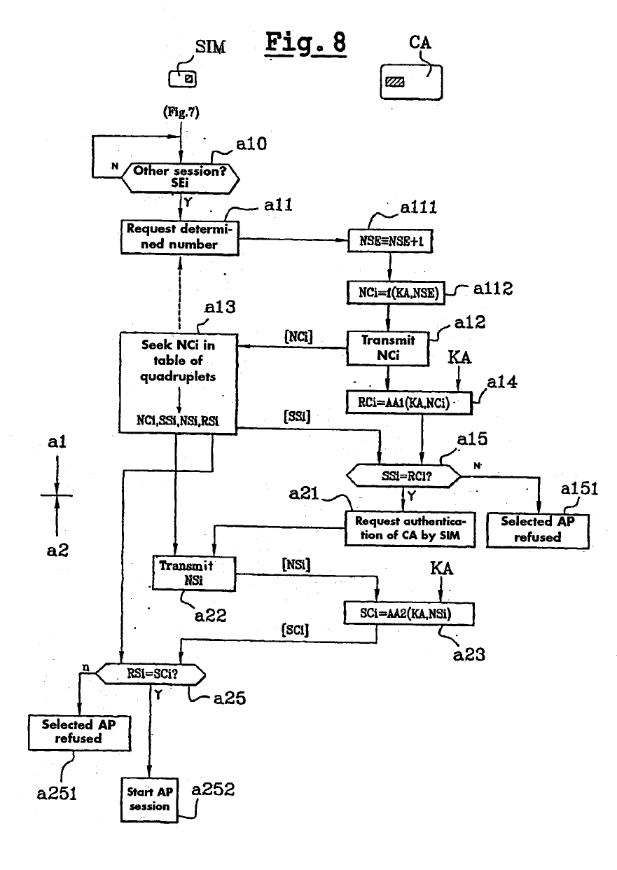

FIG. 8 is a mutual card authentication algorithm for the third embodiment of the invention; and

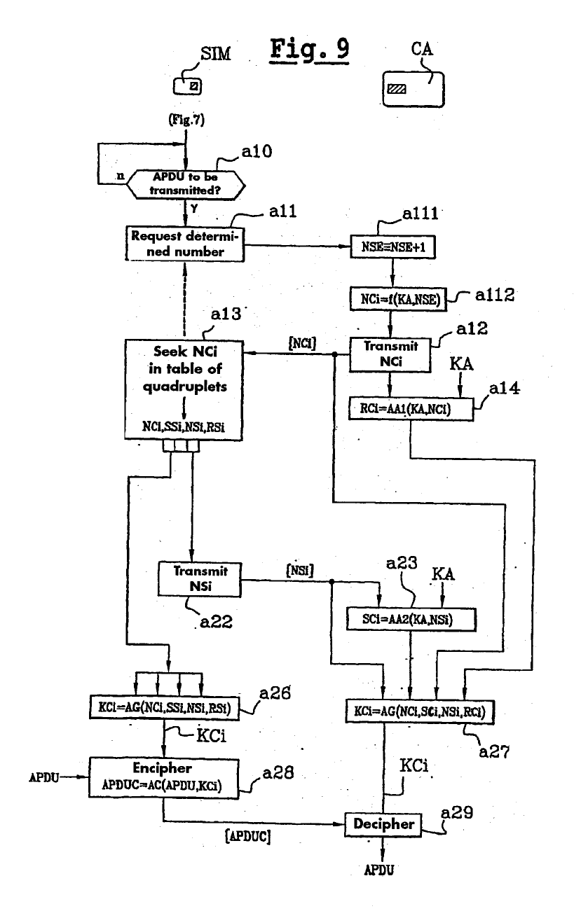

FIG. 9 is an algorithm determining a data unit enciphering key for the third embodiment.

Reference is made, by way of example, to the context of a telecommunications network of the digital cellular radio telephony network type RR, as shown in FIG. 1. A mobile radio telephony terminal TE of the radio telephony network comprises a first smart card SIM constituting an identity module with a removable microcontroller of the terminal, as well as a second smart card CA, referred to as the additional application card. The card CA is housed removably in an additional card reader LE integrated in the terminal, or possibly distinct from the terminal and connected thereto.

In FIG. 1, the radio telephony network RR is represented diagrammatically by a mobile service switch MSC for the location area where the mobile terminal TE is situated at a given time, and a base station BTS connected to the switch MSC by a base station controller BSC and to the terminal TE by radio link. The entities MSC, BSC and BTS constitute principally a fixed network through which there are transmitted in particular signalling, control, data and voice messages. The principal entity of the network RR able to interact with the card SIM in the terminal TE is the mobile service switch MSC associated with a visitor location register VLR and connected to at least one self-routing telephone switch CAA of the switched telephone network STN. The switch MSC manages communications for visiting mobile terminals, including the terminal TE, situated at a given moment in the location area served by the switch MSC. The base station controller BSC manages in particular the allocation of channels to the visiting mobile terminals, and the base station BTS covers the radio cell where the terminal MS is situated at the given moment.

The radio telephony network RR also comprises a nominal location register HLR connected to the registers VLR and similar to a database. The register HLR contains, for each radio telephone terminal, in particular the international identity IMSI (International Mobile Subscriber Identity) of the SIM (Subscriber Identity Module) card, referred to as the identity card, included in the terminal TE, that is to say the identity of the subscriber possessing the SIM card, the subscription profile of the subscriber and the number of the register VLR to which the mobile terminal is temporarily attached.

The mobile radio telephone terminal TE detailed in FIG. 2 comprises a radio interface 30 with the radio telephone network RR, comprising mainly a transmission and reception channel duplexer, frequency transposition circuits, analogue to digital and digital to analogue converters, a modulator and a demodulator, and a channel coding and decoding circuit. The terminal TE also comprises a speech coding and decoding circuit 31 connected to a microphone 310 and to a loudspeaker 311, a microprocessor 32 associated with a non-volatile program memory EEPROM 33 and a data memory RAM 34, and an input-output interface 35 serving the smart cards SIM and CA, a keypad 36 and a graphic display 37. The microprocessor 32 is connected by a bus BU to the interface 30, to the circuit 31, and to the memories 33 and 34 and by another bus BS to the input-output interface 35. The microprocessor 32 manages all the processing of the data in base band which the terminal receives and transmits after frequency transposition, in particular relating to protocol layers 1, 2 and 3 of the ISO model, and supervises data exchanges between the network RR through the radio interface 30 and the SIM card through the input-output interface 35.

The smart card SIM is connected to the input-output interface 35 including at least one card reader LE in the terminal, and peripheral connections on the mobile terminal. In the smart card SIM there is integrated a first controller comprising mainly a microprocessor 10, a memory 11 of the ROM type including an operating system of the card and communication and application algorithms, a non-volatile memory 12 of the EEPROM type which contains all the characteristics related to the subscriber, notably the international identity of the subscriber IMSI, and a memory 13 of the RAM type intended essentially for processing data to be received from the microcontroller 32 included in the terminal and the second card CA and to transmit to these.

According to the invention, several items of software are included in advance in the ROM 11 and EEPROM 12 memories in order to manage applications in additional cards CA. In particular, the algorithm of the protection method according to the invention shown in FIG. 3, or 6, or 7 is implemented in the memories 11 and 12. Authentication algorithms AA1 and AA2 used for the protection according to the invention are also implemented in the memories 11 and 12.

Like the SIM card Cl, the additional smart card CA includes a second controller comprising principally a microprocessor 20, a ROM memory 21 including an operating system for the card CA and one or more applications AP and the authentication algorithms AA1 and AA2 specific to the invention, a non-volatile memory 12 of the EEPROM type, and a RAM memory 13 which processes data to be received from the microcontroller 32 and from the processor 10. The non-volatile memory 22 also contains, according to the invention, an identifier of the card CA consisting of a serial number NS determined by the supplier of the card CA, and a respective identifier AID and a respective key KA for each application.

The card CA is for example a bank card, an electronic purse card or a gaming card.

The ROM and EEPROM memories 11, 12, 21 and 22 in the cards SIM and CA comprise communication software for dialoguing firstly with the microprocessor 32 of the terminal TE and secondly between the processors 10 and 20 through the terminal TE, that is to say through the microprocessor 32 and the input-output interface 36.

To dialogue with them, the SIM card and the additional card CA are proactive in order to trigger actions in the mobile terminal MS by means of preformatted commands in accordance with the “T=0” protocol of ISO 7816-3 and encapsulated according to recommendation GSM 11.14 (SIM Toolkit). For example, the terminal TE periodically interrogates in order to receive menus to be displayed transmitted by the card. The aforementioned recommendation extends the set of commands from the operating system included in the memory 11, 21 of the smart card SIM, CA in order to make available to the other card CA, SIM data transmitted by the smart card CA, SIM.

As will be seen below, the terminal TE is considered to be transparent to data exchanges between the cards SIM and CA in the context of the protection method according to the invention.

Typically, the controller in the additional card CA communicates with the terminal TE by means of exchanges of commands and responses between the controllers in the two cards SIM and CA, then relayed by exchanges of commands and responses between the controller of the card SIM and the terminal. All the typically proactive exchanges between the terminal and the card CA are thus made through the card SIM which appears, for the terminal, to be the executor of each application selected in the card CA.

For the three preferred embodiments of the method of the invention, a first specialised server SO belonging to the operator of the radio telephone network RR is provided. The server SO is for example a short message service server (Short Message Service Centre) which is connected to the switch MSC of the radio telephone network RR through an access network RA, for example an integrated service digital network ISDN. The address ASO of the server SO is pre-stored in the non-volatile memory 12 of the SIM card. In each short message established by the SIM card, the identity IMSI is introduced therein so that the server SO can transmit a response from the SIM card in spite of the mobility of the terminal TE, after having found the pair VLR-MSC in the nominal location register HLR.

The SIM card and the short message server SO dialogue through a bi-directional short message channel SMS (Short Message Service). The terminal TE is thus transparent to the short messages between the card SIM and the server SO.

According to another variant, the server SO can be a server connected to the base station controllers BSC of the radio telephone network RR through the Internet and a packet switching network with management of mobility and accessed by GPRS (General Packet Radio Service) radio channel.

According to a first embodiment shown in FIG. 3, the protection method of the invention comprises principal steps E0 to E8. When there exists a relationship of trust between the operator of the radio telephone network RR and the supplier of applications related to the additional card CA, the service provider has entrusted a mother key KM to the operator, which mother key has been pre-stored in the short message server SO of the operator.

Initially it is assumed, at a step E0, that the terminal TE has been started up by pressing a stop-start button, and that a confidential code keyed in on the terminal keypad has been validated so as to display a main menu on the screen of the terminal TE.

At the following step E1, which can be almost simultaneous with the step E0, the terminal TE verifies that an additional card CA has been introduced in the reader LE of the terminal. If the card CA is present in the reader, the main menu displays either the name of the card CA and/or of the supplier thereof in order to select this item so as to display the list of names of applications AP contained in the card CA, when the latter contains several of them, which will be assumed hereinafter, or directly the list of proactive applications available in the card, at the following step E2.

In a variant, the previous characteristics of the additional card CA are displayed after the card SIM has validated at an intermediate step E101 the indicator of at least one radio telephone network PLMN (Public Land Mobile Network) read in the additional card CA and accessible through the card SIM and the radio telephony network RR. If none of the radio telephone network indicators is recognised by the card SIM (step E102), a message “additional card rejected” is displayed on the screen of the terminal and the method returns to the main menu, at step E0.

If, after step E1, or E101, the additional card CA is considered to be inserted and/or validated, it transmits a list of identifiers of the proactive applications available in the card CA in order to display them at step E2. The user of the terminal TE selects a proactive application AP from amongst several proactive applications available in the card CA, for example by means of a scroll or navigation key, and validates this selection. The proactive application selected in the “second” controller in the card CA is designated AP in the remainder of the description.

The card CA then transmits to the card SIM the identifier AID of the selected proactive application AP and a serial number NS of the card CA, constituting an identifier for the controller of the card CA, read in the non-volatile memory 22 at step E3. The processor 20 in the card CA marks in the memory 22 the selected proactive application AP by a match between the identifier AID and a respective key KA of the application.

At step E4, the card SIM establishes a short message containing the received parameters NS and AID and the card identity IMSI.

On reception of the short message, the server SO temporarily stores the identity IMSI, the selected application identifier AID and the card serial number NS, and seeks in a look-up table a mother key KM matching the serial number NS transmitted, or matching a prefix contained in the serial number, at step E5. The mother key particularises a set of additional cards from the same card supplier, corresponding in general to a range of card serial numbers. The mother key is diversified into “daughter” keys respectively associated with the additional cards and with the applications proposed by the additional card or cards of the supplier. If at step E5, the server SO does not recognise the serial number NS, it transmits to the card SIM a selected application refusal message so as to announce it to the user, by means of a displayed message of the “selected application refused” type, and to break the communication of the card SIM with the server SO, at step E51.

If at step E5 a mother key KM corresponds to the serial number NS of the additional card CA, the server SO determines the “daughter” key KA corresponding to the selected application AP by applying, to an application key determination algorithm AL, the identifier AID of the selected application AP, the corresponding mother key KM and the serial number NS of the card CA, at the following step E6. This procedure ensures that the application key will be different for each card and each application of one and the same card. In a variant, the daughter key KA is established in two steps, first of all with respect to the serial number NS and the mother key, and then with respect to the selected application identifier AID, or vice-versa. The “daughter” key KA thus determined is then enciphered as an enciphered key KAC at step E7, which is transmitted in a short message addressed to the card SIM in the terminal TE, according to the previously stored identity IMSI. The card SIM deciphers the key KAC as the key KA at step E8 and stores it in order to tackle a mutual authentication of the cards SIM and CA, or a determination of an enciphering key in the cards SIM and CA, described below with reference to FIG. 4 or 5.

The mutual authentication triggered by the card SIM comprises, according to the embodiment illustrated in FIG. 4, a first authentication A1 of the first card SIM by the second card CA, and then, in response to the authenticity of the card SIM, a second authentication A2 of the second card CA by the first card SIM. According to another variant of the invention, the order of the authentications is reversed: the authentication A2 of the card CA by the card SIM is first of all performed, and then, in response to the authenticity of the second card, the authentication A1 of the card SIM by the card CA is next performed.

According to yet other variants, the authentication is solely the first or second authentication A1 or A2.

The first authentication A1 assures the additional card C1 that the “daughter” key KA of the selected application AP has indeed been determined by the network RR, that is to say by the server SO. The first authentication A1 comprises steps A11 to A16.

Following step E8, the card SIM transmits a random number request message to the card CA at step A11. The card CA reads a random number NC in its non-volatile memory 22, or supplies this random number NC by virtue of a pseudo-random generator included in the processor 20, at step A12. The random number NC is transmitted from the card CA to the card SIM, which stores it temporarily. In parallel, at steps A13 and A14, the card SIM applies a first-authentication algorithm AA1 to the selected application key KA, which was transmitted by the server SO, and to the received random number NC, in order to supply a signature SS=AA1(KA, NC) transmitted to the card CA; the card CA applies to the authentication algorithm AA1 the random number NC and the key KA read in its memory 22 in order to supply a result RC=AA1(KA, NC). The signature SS received by the card CA is compared with the result RC at step A15. If the signature SS is different from the result RC, the selected application AP is refused at step A151 and the terminal TE displays a message “selected application refused”.

If the signature SS is equal to the result RC, the card CA requests the card SIM to execute the second authentication A2, by transmitting to it an authentication request at step A21.

Then the second authentication A2 presents steps A22 to A25 equivalent to steps A12 to A15 in the first authentication A1, as if the cards were interchanged.

At the end of step A21, the card SIM selects a pseudo-random number NS read in the non-volatile memory 12, or supplied by a pseudo-random generator included in the processor 10, at step A22, and transmits it in a command to the additional card CA, which stores it in RAM memory 23. The processor 20 of the additional card CA once again reads the selected application key KA in the memory, 22 in order to apply it with the random number received NS to a second-authentication algorithm AA2 at step A23. The processor 20 produces a signature SC=AA1(KA, NS). In parallel to step A24, the processor 10 of the card SIM once again reads the key KA in the memory 13 in order to apply it with the random number NS supplied to the second-authentication algorithm AA2 in order to produce a result RS=AA2(KA, NS).

Then, at step A25, in the card SIM, the result RS determined at step A24 and the signature SC transmitted by the card CA at step A23 are compared. If the result RS is different from the signature SC, the selected application is refused and a message “selected application refused” is displayed in the terminal at step A251. Otherwise, in response to the authenticity of the additional card CA by the card SIM signalled by RS=SC, a session of the selected proactive application is executed at step A252.

Although the authentication algorithms AA1 and AA2 are considered above to be different, they may as a variant be identical.

According to variants of the first and second embodiments, the mutual authentication method shown in FIG. 4 is replaced by a data unit enciphering key determination method shown in FIG. 5.

This method comprises steps A11 to A14 similar to those of the first authentication in the first authentication A1, and steps A22 to A24 similar to those in the second authentication A2. However, at step All, the authentication request is replaced by a protection request so that firstly the card CA transmits the random number NC to the card SIM at step A12 and secondly the card SIM transmits the random number NS to the card CA at step A22. According to this data unit protection, neither the signature SS of the card SIM nor the signature SE of the additional card CA are exchanged; the random numbers NC and NS which are transmitted from one card to the other are respectively stored at steps A13 and A23.

After the result and signature determination steps A13 and A24 in the card SIM, and A14 and A23 in the card CA, an enciphering key KC is determined by applying the random numbers NC and NS, the signature SS and the result RS to an enciphering key generation algorithm AG at a step A26 in the card SIM, and at a step A27 in the additional card CA.

The enciphering key KC is used at a step A28 in order to encipher an application protocol data unit APDU to be transmitted from one of the cards, for example the card SIM, to the other card CA, and at a step A29 in order to decipher the enciphered unit APDUC in the said other card.

In practice, the same enciphering key can be used for enciphering-deciphering a first data unit, such as a command from the card SIM to the card CA, and a second data unit, such as a response from the card CA to the card SIM. Each time a command-response pair is to be exchanged, a respective enciphering key is thus determined.

In a variant, the key KC serves to sign each data unit APDU to be transmitted, or serves to sign and encipher each data unit. The enciphering key/data unit signature can be used for a longer time than for the enciphering of a command/response pair, for example for the entire duration of a session. Session means the period which elapses between the start of use of an application AID and the end of its use.

The second embodiment of the method of the invention is implemented when the additional card supplier does not have sufficient trust in the operator of the radio telephone network RR to entrust the mother key KM to him. In response to the request for the application key selected by the card SIM, it is not the server SO of the operator which supplies the requested key KA but a second server SP belonging to the service provider issuing the additional cards.

As illustrated in FIG. 1, the server SP (service provider) is situated outside the radio telephone network RR and is for example connected to the switched telephone network STN through a high-throughput network RHD such as the Internet. As will be seen hereinafter for the second embodiment, but also for a third embodiment of the invention, the card SIM does not communicate directly with the server SP of the service provider, but through the server SO of the operator. The server SO is also connected to the high-throughput network RHD and has an address table for servers of additional card suppliers so as to make an address ASP of a respective server SP correspond to each serial number NS of additional cards, or to a prefix of this serial number, that is to say to a category of additional cards.

The server SO receives short messages transmitted by the switch MSC to which the terminal TE is for the time being attached, interprets them, as will be seen below, and encapsulates them in IP (Internet Protocol) messages in order to route them to the server SP through the network RHD. In the other transmission direction, the server SO recovers data messages IP containing selected-application keys, transmitted by the server SP, and de-encapsulates them suitably in order to transmit them, preferably after deciphering and enciphering, via the networks RA and RR, to the terminal TE containing the card SIM.

The protection method according to this second embodiment comprises, as shown in FIG. 6, steps EO to E4 already described with reference to FIG. 3 and, after step E4, steps E9 to E15.

In response to the short message containing the identity IMSI of the card SIM, the serial number NS of the additional card CA and the identifier AID of the selected application AP transmitted at step E4, the server SO stores the identity IMSI, the identifier AID and the serial number NS and consults a look-up table between the serial numbers of the additional cards and the addresses of the servers of suppliers of these additional cards, at step E9. If the serial number NS of the card CA is not found in the above table, the server SO transmits a message refusing the selected application to the card SIM, which displays the message “selected application refused” and breaks off the communication with the server SO, at step E91.

If an address ASP of a server SP is found in the look-up table with the serial number received NS, the server SO establishes a message IP containing the supplier server address ASP read in the table, the address ASO of the server SO, the selected application identifier AID and the card serial number NS, at step E10.

In response to this message IP, the server SP stores the data ASO, AID and NS, and applies, to an application key determination algorithm AL, the received application identifier AID, the received serial number NS and the corresponding mother key KM for the category of cards to which the additional card CA belongs, at step E11. The execution of the diversified key algorithm AL produces a “daughter” key KA. The key KA is next enciphered as an enciphered key KACH which is encapsulated in a message IP in order to be transmitted according to the address ASO to the short message server SO, through the network RHD, at step E12.

The enciphered key KACH is deciphered as the key KA, which is stored in the server SO at step E13. Then the server SO reads the identity IMSI so as to find the terminal TE by means of the register HLR, and enciphers the received key KA as another enciphered key KAC, which is encapsulated in a short message transmitted to the terminal TE at step E14.

From the short message received by the card SIM there is extracted the enciphered key KAC, which is deciphered as the initial key KA at step E15. The key KA is then stored in the RAM memory 13 of the card SIM in order to use it for the mutual authentication of the cards SIM and CA according to the algorithm shown in FIG. 4, or for the data unit enciphering key determination according to the algorithm shown in FIG. 5.

It should be noted that the enciphered keys KAC and KACH are a priori different, the enciphering-deciphering algorithm between the server SP and SO being a priori different from the enciphering-deciphering algorithm between the server SO and the card SIM.

In the third embodiment of the protection method of the invention, the additional-card supplier has even less trust in the operator of the radio telephone network RR and does not wish to communicate to him the key KA associated with the selected application AP. The supplier communicates to the operator only pairs of couples consisting of random number and “session keys”. The session keys are signatures or results in the sense of the authentications A1 and A2 already described with reference to FIG. 4 and are stored in the card SIM in order to be used during the sessions of the selected application AP.

The third embodiment of the invention comprises steps E0 to E4 described with reference to FIG. 3 and steps E9 to E11 described with reference to FIG. 6, as well as steps E16 to E20 after step E11 as shown in FIG. 7.

After step E11, when the server SP of the additional-card supplier has supplied the daughter key KA of the selected application AP according to the identifier AID, the serial number NS and the mother key KM, the server SP seeks, in a table of lists of quadruplets, a list corresponding to the application key KA, at step E16. This list comprises several sets of parameters dependent on the determined key KA, such as I quadruplets [NC1, SS1, NS1, RS1] to [NCI, SSI, NSI, RSI] respectively for I sessions SE1 to SEI of the selected application AP. A session of the selected application is the execution of the application between two tasks executed by the card SIM, for example after having switched on the terminal TE or after having quit another application. The integer I can be equal to a few tens.

As with the signature SS according to the first authentication A1, a signature SSi, with 1≦i≦I, results from the application of the key KA and a determined number NCi to the first authentication algorithm AA1, that is to say SSi=AA1 (KA, NCi). The number NCi is not random, as will be seen below, but is determined by the application of the key KA and a respective integer number to a function f, the integer number being incremented by a unit as the quadruplets are created. As with the result RS in the second authentication A2, a result results from the application of the key KA and the random number NSi to the second authentication algorithm AA2, that is to say RSi=AA2 (KA, NSi).

The list of I quadruplets is then encapsulated in a message IP which is transmitted according to the address ASO from the server SP to the short message server SO through the network RHD. The server SO de-encapsulates the message IP and stores the list of I quadruplets. The identity IMSI attached to the card SIM is read in the server SO in order to find the terminal TE by means of the register HLR, at step E17. The list of quadruplets is then encapsulated in short messages transmitted from the server SO to the card SIM through the networks RA and RR. Finally, the I quadruplets are extracted from the short messages received and stored in the non-volatile memory 22 of the card SIM in order to use them for the next I sessions of the selected application AP, which each commence with a mutual authentication of the cards SIM and CA, as shown in FIG. 8, or by the data unit enciphering key determination according to the algorithm in FIG. 9.

When the stock of I quadruplets is exhausted after I sessions of the selected application, that is to say when the I quadruplets have each been used no more than once, as indicated at step E19 in FIG. 7, the method returns to step E19 following a quadruplet list request by the card SIM to the server SP through the server SO at step E20. The server SP then supplies a new list of quadruplets.

According to a first variant, for each session, the cards SIM and CA authenticate each other mutually, in a similar manner to the authentications A1 and A2, as shown in FIG. 8. In this figure, the first and second authentications are designated by the references a1 and a2, because of a few differences which will emerge below. Prior to the first authentication a1, it is assumed that the card SIM has stored at least the quadruplet [NCi, SSi, NSi, RSi] normally intended for the session SEi which is activated at an initial step a10.

Compared to the authentication A1, the card SIM fails to recognise the selected application key KA. The additional card CA cannot randomly generate the number NCi since it is possible for the list communicated to the card SIM to contain all the signatures corresponding to all the random numbers. Thus, after the random number request at step all, the additional card CA increments by one unit a session number counter NSE included in the processor 10, at a step a111. The counter has a sufficiently high maximum count, for example corresponding to at least four bytes, for its count to be able to be incremented by one unit at each session during the life of the card CA. The card CA then determines the number NCi at step a112 by applying the integer number NSE and the application key KA read in memory 22 to the function f contained in the ROM memory 21. The determined number NCi is then transmitted to the “first” controller in the card SIM so that the latter selects all the parameters [NCi, SSi, NSi, RSi] in the table of the quadruplets received according to the determined number NCi transmitted at step a13.

Although a priori the number NCi is redundant with the number NCi contained in the corresponding quadruplet, this addressing of the table of quadruplets received by the number transmitted NCi remedies for example an authentication phase which has ended abnormally, for example because of the radio telephone terminal TE being switched off during this phase. This causes a shift in the number NSE of the current session SSi. If the card SIM finds that the number NCi has already been used for an authentication a1 since the reception of the last list of quadruplets, it requests another number at step all, as indicated in dotted lines between steps a13 and a11 in FIG. 8; the card SIM marks the unused quadruplets corresponding to the numbers NCi which have been skipped between the numbers NCi found corresponding to two successive sessions.

At step a13, the first authentication a1 of the card SIM in the card CA consists of communicating the signature SSi of the card SIM to the card CA, and performing steps a14, a15 and a151 as steps A14, A15 and A151 for calculating the result RCi of the application of the determined number NCi and of the key KA to the first algorithm AA1 and comparing the result RCi with the signature SSi of the selected set.

Likewise, the second authentication a2 of the card CA in the card SIM commences with a request by the card CA at step a21 and a communication of the random number NSi of the set selected, from the card SIM to the card CA, at step a22. Then steps a23 and a25, a251 and a252 similar to steps A22, A23, A25, A251 and A252 are executed in order to determine a signature SCi resulting from the application of the random number communicated NSi and of the key KA to the second algorithm AA2 in the card CA, and then in order to compare the result RSi of the selected assembly with the signature SCi communicated by the card CA to the card SIM.

After step a15 or step a25, when the corresponding comparison is negative, the session of the selected application is refused (step a151 or a251) On the other hand, after step a25, when the result RSi is equal to the signature SCi, the session SEi of the selected application is commenced (step a252).

According to a second variant shown in FIG. 9, by analogy with FIG. 5, the cards SIM and CA do not mutually communicate to each other the signatures SSi and SCi and communicate to each other only the numbers NCi and NSi, and the comparison steps a15 and a25 in FIG. 8 are omitted for the determination of an enciphering key, for example when the card SIM wishes to transmit a unit APDU at step a10.

After step a10, the enciphering key results from the following steps:

incrementing at step a111 an integer number NSE of a unit in order to determine, with the application key KA, a number NCi at step a112,

transmitting at step a12 the determined number NCi to the “first” controller of the card SIM in order to select at step a13 the set of parameters NCi, SSi, NSi and RSi containing the determined number in the card SIM,

determining at step a14 the result RCi of the set of parameters selected according to the application of the said determined number NCi and of the key KA to the first algorithm AA1 in the “second” controller of the additional card CA,

communicating at step a22 the random number NSi of the set of parameters selected to the card CA,

determining at step a23 the signature SCi of the set of parameters selected by applying the random number communicated NSi and the key KA to the second algorithm AA2 in the card CA, and

determining at steps a26 and a27 an enciphering key KC according to the set of parameters selected in the card SIM and the card CA, so as to encipher and/or sign a data unit APDU with the enciphering key KC to be transmitted from one of the cards to the other.

Although the invention has been described above in relation to the protection of data exchanges between the controllers of two smart cards SIM and CA, the invention applies in general terms to protection between any first controller and any second controller which have to communicate with each other, the term controller covering a data processing means or unit, such as a microprocessor, or more completely an entity such as a terminal, a server etc. For example, the first controller may be a point of sale terminal and the second controller a credit card, the telecommunications network to which the terminal is connected then being the switched telephone network. According to another example, the first and second controllers are those of a dual-mode radio telephone terminal.

1. A method for protecting data exchanges between first and second controllers (SIM, CA), the first controller (SIM) managing communications to a telecommunications network (RR) for applications implemented in the second controller, the second controller containing a controller identifier (NS) and keys (KA) of the applications derived from a mother key (KM), characterised by the following steps for each application selected (AP) in the second controller (CA):
transmitting (E3, E4) the identifier (NS) of the second controller (CA) and an identifier (AID) of the selected application (AP) from the second controller (CA) to a distant protection means (SO; SO, SP) through the first controller (SIM),
making a mother key (KM) in the protection means correspond (E5, E9) to the identifier of the second controller (NS),
determining (E6, E11) the key (KA) of the selected application according to the selected-application identifier transmitted (AID), the corresponding mother key (KM) and the second-controller identifier (NS) in the protection means,
transmitting (E7, E8; E12-E15) at least one parameter (KA; SSi, RSi) dependent on the determined application key (KA) from the distant protection means to the first controller (SIM), and
using (A11-A25; a10-a29) the parameter in at least the first controller (SIM) in order to make secure at least one data exchange related to the selected application between the first and second controllers.

2. A method according to claim 1, according to which the said parameter is the determined application key itself (KA) which is transmitted (E7-E8; E12-E15) in enciphered form (KACI, KAC) from the distant protection means (SO; SO, SP) to the first controller (SIM).

3. A method according to claim 1 or 2, according to which the distant protection means is a server (SO) in the said telecommunications network (RR) and contains a table (E5) for making sets of second-controller identifiers (NS) correspond to mother keys (KM).

4. A method according to claim 1 or 2, according to which the distant protection means comprises a first server (SO) included in the telecommunications network (RR) and containing a table (E9) for making sets of second-controller identifiers (NS) correspond to addresses (ASP) of second servers, and second servers (SP) connected to the first server (SO) and associated respectively with sets of second-controller identifiers (NS) corresponding to mother keys, and according to which the second server (SP) is addressed by the first server (SO) in response to the identifier (NS) of the second controller transmitted, determines (E11) the key (KA) of the selected application and transmits (E12) at least the said parameter (KA) to the first controller (CA) through the first server (SO).

5. A method according to claim 3 or 4, according to which the said parameter is the determined application key itself (KA) and is used in the first controller (SIM) in order to participate in an authentication (A1) of one of the first and second controllers by the other controller, and then in an authentication (A2) of the other controller by the said controller in response to the authenticity of the said one controller, before executing a selected application session solely in response to the authenticity of the said other controller.

6. A method according to claim 3 or 4, according to which the said parameter is the determined key itself (KA) of the selected application (AP) and is used in the first controller (SIM) in order to determine (A26) an enciphering key (KC) dependent on a first random number (NC) supplied (A12) by the second controller (CA) to the first controller (SIM) and a second random number (NS), which is supplied (A22) by the first controller (SIM) to the second controller (CA) in order to determine (A27) the enciphering key in the second controller, so as to encipher and/or sign (A28, A29) a data unit (APDU) with the enciphering key (KC) to be transmitted from one of the controllers to the other.

7. A method according to claim 4, according to which several sets of parameters (NCi, SSi, NSi, RSi) dependent on the determined key (KA) and not comprising this are transmitted by the second server (SP) to the first controller (SIM), and each set of parameters comprises a number (NCi) which is determined according to the determined key (KA) and a respective integer number (NSE), a signature (SSi) resulting from the application of the determined key (KA) and the determined number (NCi) to a first algorithm (AA1), a random number (NSi), and a result (RSi) resulting from the application of the determined key (KA) and of the random number to a second algorithm (AA2).

8. A method according to claim 7, comprising, before the execution of each section of the selected application (AP) in the second controller (CA), the following steps:
incrementing (a111) an integer number (NSE) of a unit modulo the number of sets of parameters in order to determine (a112), with the application key (KA), a number (NCi),
transmitting (a12) the said determined number (NCi) to the first controller (SIM) in order to select (a13) the set of parameters (NCi, SSi, NSi, RSi) containing the said determined number in the first controller (SIM),
authenticating (a1) the first controller (SIM) in the second controller (CA) by comparing the signature (SSi) of the selected set and a result (RCi) of the application of said determined number (NCi) and of the key (KA) to the first algorithm (AA1),
communicating (a22) the random number (NSi) of the selected set to the second controller (CA), and
authenticating (a2) the second controller (CA) in the first controller (SIM) by comparing (a25) the result (RSi) of the selected set and a signature (SCi) resulting (a23) from the application of the random number communicated (NSi) and of the key (KA) to the second algorithm (AA2) in the second controller (CA).

9. A method according to claim 7, according to which
incrementing (a111) an integer number (NSE) of a unit in order to determine (a112), with the application key (KA), a number (NCi),
transmitting (a12) the said determined number (NCi) to the first controller (SIM) in order to select (a13) the set of parameters (NCi, SSi, NSi, RSi) containing the said determined number in the first controller (SIM),
determining (a14) the result (RCi) of the set of parameters selected according to the application of the said determined number (NCi) and of the key (KA) to the first algorithm (AA1) in the second controller (CA),
communicating (a22) the random number (NSi) of the set of selected parameters to the second controller (CA),
determining (a23) the signature (SCi) of the set of parameters selected by applying the communicated random number (NSi) and the key (KA) to the second algorithm (AA2) in the second controller (CA), and
determining (a26, a27) an enciphering key (KCi) according to the said selected set of parameters in the first and second controllers (SIM, CA), so as to encipher and/or sign a data unit (APDU) with the enciphering key (KC) to be transmitted from one of the controllers to the other.

10. A method according to any one of claims 1 to 9, according to which the first controller is that of an identity card (SIM) in a mobile radio telephone terminal (TE) and the second controller is that of an additional card (CA) able to be inserted in a reader (LE) of the terminal.
